(19) United States
(12) Patent Application Publication
(10) Pub. No.: US 2016/0259710 A1
(43) Pub. Date: Sep. 8, 2016

(54) CODE CONSISTENCY CHECKING METHOD

(71) Applicant: HANGZHOU GLORITY SOFTWARE LIMITED, Hangzhou (CN)

(72) Inventors: Qingsong XU, Hangzhou (CN); Huan LUO, Hangzhou (CN); Mingquan CHEN, Hangzhou (CN)

(73) Assignee: HANGZHOU GLORITY SOFTWARE LIMITED, Hangzhou (CN)

(21) Appl. No.: 14/969,578

(22) Filed: Dec. 15, 2015

(30) Foreign Application Priority Data
Mar. 2, 2015 (CN) 201510092936.6

(51) Int. Cl. G06F 11/36; G06F 9/44; G06F 17/30

(52) U.S. Cl. CPC G06F 11/3616; G06F 17/30106; G06F 17/30371; G06F 8/71

(57) ABSTRACT

The present invention belongs to the technical field of software development and maintenance, and more especially related to a code consistency checking method. The consistency checking method of the present invention sustains the code consistency checking and maintenance in large-scale program at the code segment and function level rather than checking of duplicated files only, and maintains the consistency checking of duplicated codes at the development stage in the software development cycle, namely, before test phase, so as to greatly reduce the fix time of errors caused by inconsistency problems.

### BACKGROUND OF THE INVENTION

1. Technical Field

The present invention belongs to the technical field of software development and maintenance, and more especially related to a code consistency checking method.

2. Description of Related Art

Currently, there exist some tools and methods for detecting code duplication in the field of software development. These can effectively detect duplicated blocks of code, but this function has many limitations to detecting and finding problems. In real-life applications, a great number of duplicated blocks exist in the code for many programs, especially for the software which was developed and has been maintained for many years. It is unlikely and costly to eliminate these duplications fully. With regard to these situations, there is no pertinent solution to avoid the problem introduced by duplicated codes and make the changes consistently. When the developer changed something in one block of duplicated code, it's easy to miss to change it in other blocks of code that duplicated with the block he changed, but missing those changes may directly cause issues since they may also need make similar changes. Practices has proven that many defects in large and long history application are caused by the inconsistent code change the duplicated code, the present invention aims to resolve the inconsistent code change in duplicated blocks.

### BRIEF SUMMARY OF THE INVENTION

The present invention aims at providing a code inconsistency detection method in order to reduce errors caused by code inconsistency.

To address the technical problem above, the present invention provides the following technical solution:

A code consistency checking method, comprising the following steps:

1) Perform code duplication detection to the original codes and store the result into the database.

2) Retrieve all file information involving the changed codes according to the code base before the developer submits the changed codes.

3) Obtain the information of all duplicated code segments contained in the changed files of this code submit form the database as described in Step 1).

4) Compare the changed codes with the duplicated code segments in Step 3), judge whether the changed codes submitted have changed these duplicated code segments. If the answer is NO, there is no inconsistency problem and the checking passes; if YES, perform the next checking.

5) According to the retrieval of the files where the duplicated code segments changed by the changed codes lie in the database as described in Step 1), if the files retrieved are not within the list of files involving the changed codes, it indicates some of the duplicated code segments before change are not changed, namely consistency problem exists. Report inconsistent code change in such case. But if the files retrieved are within the list of files involving the changed codes, it indicates consistency problem may exist. Conduct the next detection in such a case.

6) Compare the changed code with the duplicated code segments in the files within the list of files involving the changed codes retrieved. If the changes of these duplicated code segments are consistent, there is no inconsistency problem. But if the changes of these code segments are inconsistent, there is inconsistency problem. Report inconsistent code change in such case.

7) Run code duplication detection and update the database after changes are submitted.

Furthermore, the code duplication detection in Step 1) is to detect the code segments and functions.

Furthermore, the storage structure of the database in Step 1) includes three layers, namely file, link of file and code segment, and code segment.

Furthermore, the length of the code segment can be configured according to actual needs.

The beneficial effects of the present invention are as below:

1. Sustain the code consistency checking and maintenance in large-scale program at the code segment and function level rather than checking of duplicated files only.

2. Store the duplicated information in codes into the database, and keep regular updating to get the duplicated code information in the latest codes real time.

3. Maintain the consistency checking of duplicated codes at the development stage in the software development cycle, namely, before test phase, so as to greatly reduce the fix time of issues caused by inconsistency problems.

### BRIEF DESCRIPTION OF THE SEVERAL VIEWS OF THE DRAWINGS

FIG. 1 is the storage structure of the database according to the present invention;

FIG. 2 is the flow chart of the present invention.

### DETAILED DESCRIPTION OF THE INVENTION

The present invention is detailed in combination with the embodiments below.

A code consistency checking method, comprising the following steps:

1) Conduct code duplication detection to the original codes and store the result into the database.

2) Retrieve all file information involving the changed codes according to the code version base before the developer submits the changed codes.

3) Obtain the information of all duplicated code segments contained in the files of this code submit from the database as described in Step 1).

4) Compare the changed codes with the duplicated code segments in Step 3), judge whether the changed codes submitted have changed these duplicated code segments. If the answer is NO, there is no inconsistency problem and the checking passes; if YES, perform the next checking.

5) According to the retrieval of the files where the duplicated code segments changed by the changed codes lie in the database as described in Step 1), if the files retrieved are not within the list of files involving the changed codes, it indicates some of the duplicated code segments before change are not changed, namely inconsistency problem exists. Report inconsistent code change in such case, but if the files retrieved are within the list of files involving the changed codes, it indicates inconsistency problem may exist. Conduct the next checking in such a case.

6) Compare the changed code with the duplicated code segments in the files within the list of files involving the changed codes retrieved. If the changes of these duplicated code segments are consistent, there is no inconsistency problem. But if the changes of these code segments are inconsistent, there is inconsistency problem. Report inconsistent code change in such a case.

7) Run code duplication detection and update the database after changes are submitted.

Furthermore, the codec duplication detection in Step 1) is to detect the code segments and functions.

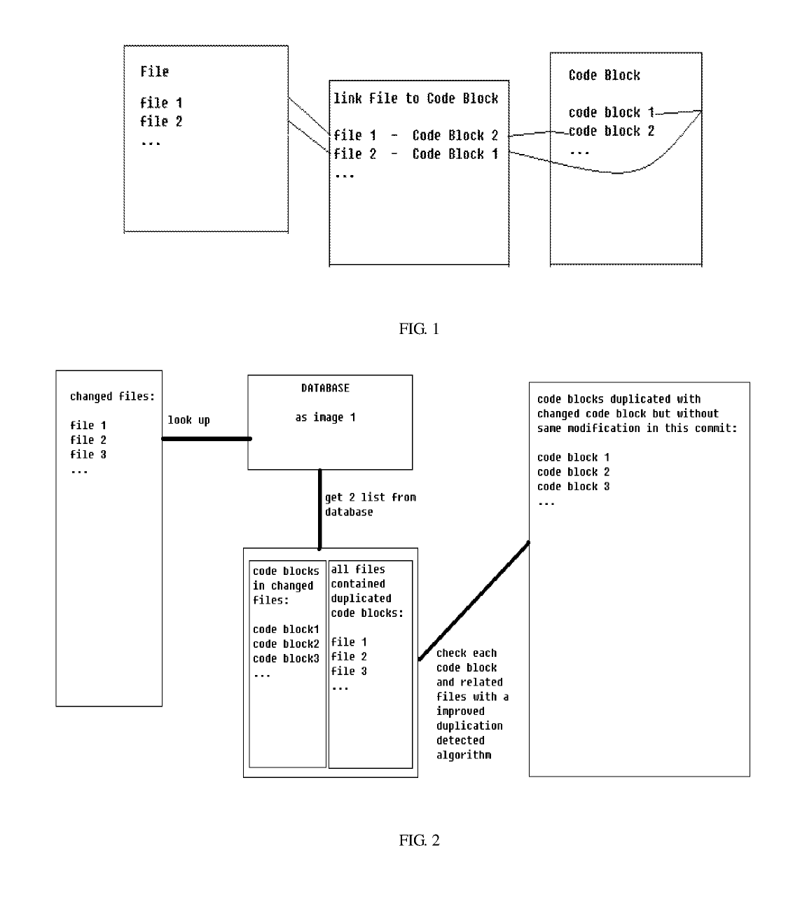

Furthermore, the storage structure of the database in Step 1) includes three layers, namely file, link of file and code segment, and code segment, as shown in FIG. 1.

The length of the code segment can be configured according to actual needs.

The whole detection workflow is as shown in FIG. 2.

This method is not only applicable to the consistency checking of codes, but also to that of general files, and files of different formats.

To sum up, the description above is just the preferred embodiment of the present invention. All equivalent changes and modifications made according to the patented scope as claimed by the present invention are all within the scope of the present invention.

1. A code consistency checking method, characterized in that, comprising the following steps:
1) Conduct code duplication detection to the original codes and store the result into the database.
2) Retrieve all file information involving the changed codes according to the code version base before the developer submits the changed codes.
3) Obtain the information of all duplicated code segments contained in the files involving the changed codes according to the retrieval of the changed files in the database as described in Step 1).
4) Compare the changed codes with the duplicated code segments retrieved in Step 3); judge whether the changed codes submitted have changed these duplicated code segments. If the answer is NO, there is no inconsistency problem and the detection passes, if YES, perform the next detection.
5) According to the retrieval of the files where the duplicated code segments changed by the changed codes lie in the database as described in Step 1), if the files retrieved are not within the list of files involving the changed codes, it indicates some of the duplicated code segments before change are not changed, namely inconsistency problem exists. Report inconsistent code change in such case, but if the files retrieved are within the list of files involving the changed codes, it indicates inconsistency problem may exist, conduct the next checking in such case.
6) Compare the changed code with the duplicated code segments in the files within the list of files involving the changed codes retrieved. If the changes of these duplicated code segments are consistent, there is no inconsistency problem. But if the changes of these code segments are inconsistent, there is inconsistency problem. Report inconsistent code change in such a case.
7) Run code duplication detection and update the database after changes are submitted.

2. The code consistency checking method as claimed in claim 1, characterized in that the repeatability detection in Step 1) is to check the code segments and functions.

3. The code consistency checking method as claimed in claim 1, characterized in that the storage structure of the database in Step 1) includes three layers, namely file, link of file and code segment, and code segment.

4. The code consistency checking method as claimed in claim 1, characterized in that the length of the code segment can be configured according to actual needs.

5. The code consistency checking method as claimed in claim 2, characterized in that the length of the code segment can be configured according to actual needs.

6. The code consistency checking method as claimed in claim 3, characterized in that the length of the code segment can be configured according to actual needs.
